(19) United States
(12) Patent Application Publication
(10) Pub. No.: US 2025/0075343 A1
(43) Pub. Date: Mar. 6, 2025

(54) CRUDE OIL PROCESSING PLANT WASTEWATER TREATMENT WITH CO-PRODUCTION OF HYDROGEN FOR CLEAN ENERGY

(71) Applicant: Saudi Arabian Oil Company, Dhahran (SA)

(72) Inventors: Ameerah Bokhari, Thuwal (SA); Faisal Mohammed Alissa, Dammam (SA); Meaad Mohsen Baabdullah, Thuwal (SA); Mohammad Abdulazim Alrowaie, Dhahran (SA); Nora Khalid AlSudairi, Dhahran (SA)

(21) Appl. No.: 18/240,127

(22) Filed: Aug. 30, 2023

(51) Int. Cl. C25B 5/00; C02F 1/26; C25B 1/04; C25B 9/19; C25B 15/08; H01M 16/00

(52) U.S. Cl. CPC C25B 5/00; C02F 1/265; C25B 1/04; C25B 9/19; C25B 15/083; C25B 15/087; H01M 16/003; C02F 2101/32; C02F 2209/10

(57) ABSTRACT

A wastewater stream is flowed from a separator to an anode side of a microbial electrolysis cell (MEC). The wastewater stream includes water and hydrocarbons. The separator is positioned in a gas-oil separation plant. The MEC electrolyzes the hydrocarbons to produce hydrogen ions. A membrane separates the MEC into the anode side and a cathode side. The membrane allows the hydrogen ions and water molecules to pass through the membrane from the anode side to the cathode side, thereby forming a treated wastewater stream at the cathode side. The MEC combines the hydrogen ions at the cathode side to produce hydrogen gas. The treated wastewater stream and a hydrogen gas stream is discharged from the cathode side. The hydrogen gas stream includes the hydrogen gas produced by the MEC. The hydrogen gas stream is oxidized into water. Electrical power is generated in response to oxidizing the hydrogen gas into water.

### TECHNICAL FIELD

This disclosure relates to power production in hydrocarbon processing facilities.

### BACKGROUND

Gas oil separation plants (GOSP) are employed to process crude oil received from a wellhead. The crude oil received may be obtained via the wellhead from a hydrocarbon-bearing reservoir in a subterranean formation. The GOSP may have a train of vessels that operate at sequentially lower pressure to remove volatile gases, water, and salt from the crude oil. The GOSP may discharge the processed crude oil as export crude oil (product crude oil) for distribution including to storage and transportation for further processing, such as in a petroleum refinery.

The crude oil received at the GOSP from the wellhead typically includes produced water and is a mixture of oil, emulsified or free produced water, and gas. The crude oil may include water droplets dispersed in a continuous phase of oil. Sometimes emulsifying agents utilized in the upstream production of the crude oil are present in the crude oil received at the GOSP. The produced water in the crude oil may be salty water produced along with the crude oil. In such cases, the crude oil received at the GOSP is an oil-water emulsion and has salt in the water in the emulsion. The salt content can include chloride and bromide salts, such as sodium chloride (NaCl), calcium chloride (CaCl₂), magnesium chloride (MgCl₂), potassium chloride (KCl), and other inorganic salts. The salt in crude oil streams may generally be salt in water droplets in the crude oil stream.

Wash water (e.g., fresh water or low-salinity water), also referred to as washing water or dilution water, may be employed in the GOSP to facilitate the removal of salt to lower the salt content of the crude oil (e.g., export crude oil) to or below specification in a process called desalting. In a desalting vessel, low water-cut emulsions can be mixed with wash water to reduce (dilute) the concentration of dissolved salt in the water droplets in the crude oil. The water is separated from the crude oil in the desalting vessel, thereby reducing the salt content in the outgoing crude. In some instances, produced crude oil (export crude oil) from GOSPs should generally have a salt content of less than, for example, 10 pounds per thousand barrels (PTB) to be acceptable to certain international crude buyers.

### SUMMARY

This disclosure describes technologies relating to power production in hydrocarbon processing facilities, and in particular, biological wastewater treatment in gas-oil separation plants to produce hydrogen for generating electrical power. This disclosure describes integration of microbial electrolysis with hydrogen oxidation to simultaneously treat oil and gas wastewater and produce clean energy in a GOSP. A microbial electrolysis cell (MEC) receives wastewater from the GOSP. In response to being supplied power, the MEC simultaneously generates hydrogen gas and reduces oil content of the feed wastewater. The hydrogen gas can be used to generate power, which can be used within the GOSP. The treated wastewater exiting the MEC can be injected back into the earth for oil and gas operations.

Certain aspects of the subject matter described can be implemented as a method for powering portions of a gas-oil separation plant (GOSP). A wastewater stream is flowed from a separator to an anode side of a microbial electrolysis cell (MEC). The wastewater stream includes water and hydrocarbons. The separator is positioned in the GOSP. The MEC electrolyzes the hydrocarbons to produce hydrogen ions at the anode side. A membrane separates the MEC into the anode side and a cathode side. The membrane allows the hydrogen ions and water molecules to pass through the membrane from the anode side to the cathode side, thereby forming a treated wastewater stream at the cathode side. The MEC combines the hydrogen ions at the cathode side to produce hydrogen gas. The treated wastewater stream and a hydrogen gas stream is discharged from the cathode side. The hydrogen gas stream includes the hydrogen gas produced by the MEC. The hydrogen gas stream is oxidized into water. Electrical power is generated in response to oxidizing the hydrogen gas into water.

This, and other aspects, can include one or more of the following features. The generated electrical power can be provided to the GOSP. The treated wastewater stream can be recycled to a desalter positioned in the GOSP. The treated wastewater stream can be flowed through a membrane separator, thereby purifying the treated wastewater stream and increasing a concentration of water in the treated wastewater stream prior to recycling the treated wastewater stream to the desalter. The treated wastewater stream can be combined with seawater to form a mixed water stream. The mixed water stream can be flowed to a water treatment plant. The treated wastewater stream can be injected into a wellbore formed in a subterranean formation (for example, a disposal or injection well). The wastewater stream can have a total dissolved solids level in a range of from about 150,000 parts per million (ppm) to about 250,000 ppm. The wastewater stream can have an oil content in a range of from about 10 ppm to about 30,000 ppm.

Certain aspects of the subject matter described can be implemented as a method for powering portions of a GOSP. A wastewater stream is separated from a crude oil stream in a separator. The wastewater stream includes water and hydrocarbons. The separator is positioned in the GOSP. The hydrocarbons of the wastewater stream are electrolyzed to produce protons and a treated wastewater. The protons are combined with electrons to produce hydrogen gas. The hydrogen gas is oxidized into water. In response to oxidizing the hydrogen gas into water, electrical power is generated for use in the GOSP. At least a portion of the treated wastewater is recycled to a desalter that is positioned in the GOSP.

This, and other aspects, can include one or more of the following features. The generated electrical power can be provided to the GOSP. The treated wastewater stream can be flowed through a membrane separator, thereby purifying the treated wastewater stream and increasing a concentration of water in the treated wastewater stream prior to recycling at least the portion of the treated wastewater stream to the desalter. A second portion of the treated wastewater stream can be combined with seawater to form a mixed water stream. The mixed water stream can be flowed to a water treatment plant. A second portion of the treated wastewater stream can be injected into a wellbore formed in a subterranean formation. The wastewater stream can have a total dissolved solids level in a range of from about 150,000 ppm to about 250,000 ppm. The wastewater stream can have an oil content in a range of from about 10 ppm to about 30,000 ppm.

Certain aspects of the subject matter described can be implemented as a system for powering portions of a GOSP. The system includes a wastewater stream, an MEC, and a hydrogen fuel cell. The wastewater stream includes water and hydrocarbons. The wastewater stream is from a separator that is positioned in the GOSP. The MEC includes a membrane that separates the MEC into an anode side and a cathode side. The MEC includes an anode disposed in the anode side. The MEC includes a cathode disposed in the cathode side. The anode and the cathode are configured to connect to a power source. Microbes are disposed within the anode side. The MEC is configured to receive the wastewater stream at the anode side. The anode and the microbes are cooperatively configured to electrolyze the hydrocarbons in response to receiving power from the power source to produce hydrogen ions at the anode side. The membrane is configured to allow the hydrogen ions and water molecules to pass through the membrane from the anode side to the cathode side to form a treated wastewater stream at the cathode side. The cathode is configured to combine the hydrogen ions at the cathode side to produce hydrogen gas. The MEC is configured to discharge the treated wastewater stream and a hydrogen gas stream from the cathode side. The hydrogen gas stream includes the hydrogen gas produced by the MEC. The hydrogen fuel cell is configured to receive the hydrogen gas stream and oxygen. The hydrogen fuel cell is configured to convert the oxygen and the hydrogen gas from the hydrogen gas stream into water. The hydrogen fuel cell is configured to generate power in response to converting the oxygen and the hydrogen gas into water.

This, and other aspects, can include one or more of the following features. The system can include a desalter. The desalter can be positioned in the GOSP. The desalter can be configured to receive and utilize the treated wastewater stream from the MEC as wash water. The system can include a membrane separator. The membrane separator can be configured to receive the treated wastewater stream. The membrane separator can be configured to purify the treated wastewater stream and increase a concentration of water in the treated wastewater stream in response to the treated wastewater stream flowing through the membrane separator. The wastewater stream can have a total dissolved solids level in a range of from about 150,000 ppm to about 250,000 ppm. The wastewater stream can have an oil content in a range of from about 10 ppm to about 30,000 ppm.

The subject matter described in this disclosure can be implemented in particular implementations, so as to realize one or more of the following advantages. The production of low salinity water can be especially beneficial, for example, in arid or semi-arid climates where fresh or low-salinity water is a valuable resource. The described systems and methods produce green hydrogen, which can be used to generate electrical power for powering portions of gas-oil separation plants. These systems and methods save on operation costs and reduce the use of non-renewable water resources, such as aquifer water. These systems and methods produce a low-salinity wash water within the gas-oil separation plant, which can be directly used in the desalter(s) of the gas-oil separation plant. These systems and methods produce a wash water independent of membrane systems used in conventional water processing units (such as osmosis and reverse osmosis). These systems and methods reduce the cost of treating disposal wells and addressing injectivity issues. These systems and methods reduce the number of disposal wells necessary to inject water into subterranean formations. These systems and methods make use of the water that is produced along with crude oil, which can improve efficiency and reduce operating costs. These systems and methods produce clean energy via hydrogen, which can reduce the carbon footprint and contribution to greenhouse gas emissions by gas-oil separation plants. These systems and methods reduce and/or eliminate the risk of corrosion of flowlines and pipelines of gas-oil separation plants, thereby reducing and/or avoiding maintenance costs associated with fixing and/or replacing corroded pipe. These systems and methods mitigate and/or eliminate the need to remove organic deposits in disposal wells by reducing organic content in the treated wastewater that is injected into such disposal wells.

The details of one or more implementations of the subject matter of this disclosure are set forth in the accompanying drawings and the description. Other features, aspects, and advantages of the subject matter will become apparent from the description, the drawings, and the claims.

### DESCRIPTION OF DRAWINGS

FIG. 1 is a schematic diagram of an example gas-oil separation plant.

FIG. 2 is a schematic diagram of an example gas-oil separation plant that includes biological wastewater treatment and co-production of electrical power.

FIG. 3 is a schematic diagram of an example microbial electrolytic cell that can be implemented in the systems of FIGS. 1 and 2.

FIG. 4 is a flow chart of an example method for powering portions of a gas-oil separation plant.

FIG. 5 is a flow chart of an example method for powering portions of a gas-oil separation plant.

### DETAILED DESCRIPTION

This disclosure describes integration of microbial electrolysis with hydrogen oxidation to simultaneously treat oil and gas wastewater and produce clean energy in a GOSP. An MEC receives wastewater from the GOSP. In response to being supplied power, the MEC simultaneously generates hydrogen gas and reduces oil content of the feed wastewater. The hydrogen gas can be used to generate power, which can be used within the GOSP. The treated wastewater exiting the MEC can be injected back into the earth for oil and gas operations.

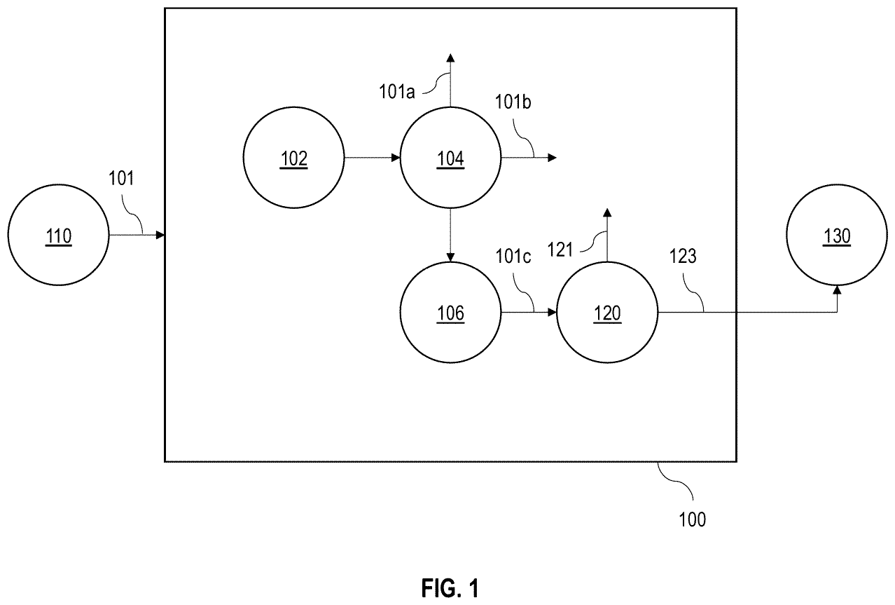

FIG. 1 is a schematic diagram of an example gas-oil separation plant (GOSP) 100 connected to a hydrocarbon-producing well 110. The GOSP 100 receives a hydrocarbon stream 101 from the well 100. The hydrocarbon stream 101 can include crude oil and/or gas. In some cases, the hydrocarbon stream 101 includes water (for example, produced water). The GOSP 100 processes the hydrocarbon stream 101 to separate phases of the hydrocarbon stream 101. The GOSP 100 includes various separators, such as a high pressure production trap (HPPT) 102, a low pressure production trap (LPPT) 104, and a water/oil separator (WOSEP) 106, which cooperate to separate the hydrocarbon stream 101 into gas 101a, oil 101b, and water 101c. The different phases of the hydrocarbon stream 101 (such as oil 101a and gas 101b) are transported elsewhere (for example, a gas processing facility, a petrochemical processing facility, a refinery, or an end user). The water 101c is treated to remove impurities to produce hydrogen gas 121 and treated water 123, using an MEC 120 to electrolyze hydrocarbons present in the water 101c to produce the hydrogen gas 121. The hydrogen gas 121 produced by the MEC 120 can be oxidized (for example, combusted or combined with oxygen in a hydrogen fuel cell) to produce electrical power. The electrical power produced from oxidation of the hydrogen gas 121 can, for example, be used to power portions of the GOSP 100. In some cases, the treated water 123 is injected back into the Earth, for example, via a water well 130. Although shown in FIG. 1 as being connected to the well 110, the GOSP 100 can optionally be connected to multiple wells and can receive and process multiple hydrocarbon streams received from the various wells.

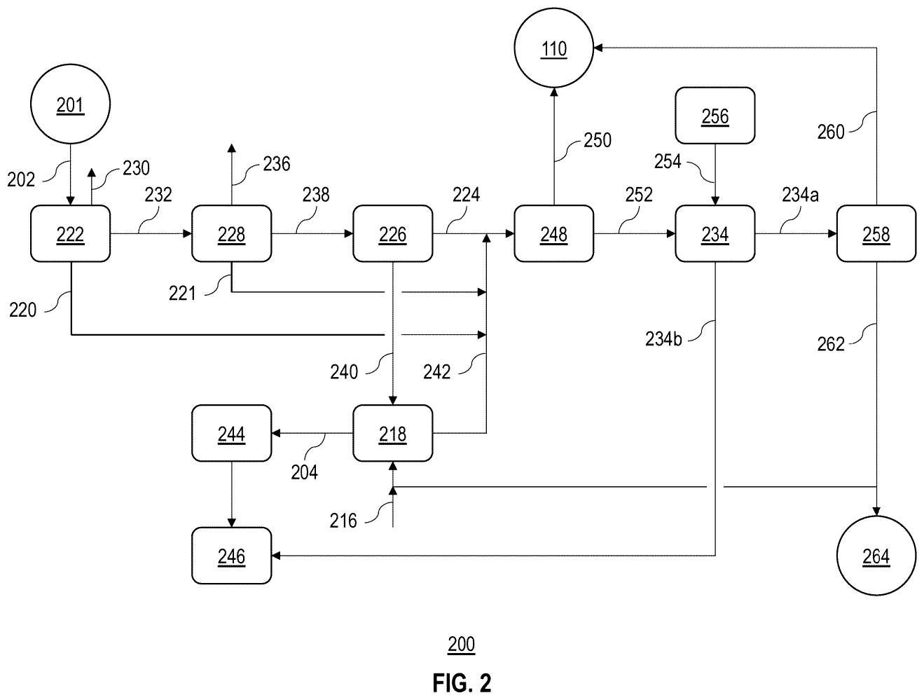

FIG. 2 is a schematic diagram of an example GOSP 200 that includes biological wastewater treatment and co-production of electrical power. The GOSP 200 processes crude oil 202 received from a wellhead 201 and discharges export crude oil 204 as product. As discussed below, the GOSP 200 removes salt from the crude oil 202. The salt is dissolved in the fine water droplets in the crude oil 202 and generally not in the crude oil 202 itself. The salt content can include chloride and bromide salts. For example, the salt content can include sodium chloride (NaCl), calcium chloride (CaCl₂)), magnesium chloride (MgCl₂), potassium chloride (KCl), and other inorganic salts. The GOSP 200 can include multiple analyzer instruments to measure salt concentration of streams internal in the GOSP 200 such that the salt concentration in the export crude 204 can be calculated. The analyzer instruments measure sodium to give the salt concentration as based on sodium chloride (NaCl). The control system (or computer system) can perform a mass balance to determine (calculate) salt content in the export crude oil 204 based on the measurements by the analyzer instruments. In view of the measurements by the analyzer instruments, the control system may direct the flowrate set point of the flow control valve (or wash-water pump) that controls the flowrate of the wash water 216 supplied to the desalter 218 vessel.

The GOSP 200 includes an MEC 248 for electrolyzing hydrocarbons and organic material present in the water separated by the GOSP 200 to produce hydrogen gas, which can then be used to generate electrical power. The electrical power produced from the hydrogen gas can, for example, be used in the GOSP 200. The water separated by the GOSP 200 and flowed to the MEC 248 includes various contaminants, which make the water difficult to process. Typical contaminants in the water separated by the GOSP 200 and flowed to the MEC 248 include mercaptans, oil/grease, phenols, ammonia, sulfide, and dissolved salts. As described previously, the water separated by the GOSP 200 also includes a high salt content. For example, the water separated by the GOSP 200 and flowed to the MEC 248 can have a total dissolved solids (TDS) in a range of from about 150,000 parts per million (ppm) to about 250,000 ppm or even greater (such as 400,000 ppm or greater). The high salinity of the water can also make processing of the water more difficult. However, the MEC 248 is configured to electrolyze the organic material and hydrocarbons to produce hydrogen gas despite the presence of such contaminants and high salinity of the water.

The multiple analyzer instruments may each be an online analyzer instrument (analyzer tool) to measure concentration of salt (e.g., NaCl) in water in a stream. The online analyzer instrument may be disposed along a conduit conveying the stream. The illustrated embodiment includes at least three such online analyzer instruments that measure salt concentration: (1) online analyzer instrument that measures salt concentration in the wash water 216; (2) online analyzer instrument that measures salt concentration in the water 220 that discharges from the high-pressure production trap (HPPT)222; and (3) online analyzer instrument that measures salt concentration in the water of the oily water 224 that discharges from the dehydrator 226 vessel. The analytical techniques, mass balances, and control schemes are discussed below with respect to subsequent figures.

The feed crude oil 202 received at the GOSP 200 from a well is as produced from a subterranean formation through a wellbore (and production manifold) to the GOSP 200. The feed crude oil 202 flows through a production manifold associated with one or more wellheads to the GOSP 200. The feed crude oil 202 may be from a well pool. The feed crude oil 202 includes water and thus is labeled as wet crude oil. The feed crude oil 202 received at the GOSP 200 may be a tight emulsion of oil and water. A tight emulsion is generally an emulsion with small and closely distributed droplets.

The GOSP 200 removes gas, water, and salt from the crude oil 202. The GOSP 200 removes hydrocarbons as gas from the crude oil via lowering pressure of the crude oil 202. The removed hydrocarbons may be light hydrocarbons (e.g., C1 to C4) and medium or heavier hydrocarbons (e.g., C5+).

The GOSP 200 includes the HPPT 222, a low-pressure production trap (LPPT) 228, the dehydrator 226, and the desalter 218. The HPPT 222, LPPT 228, dehydrator 226, and desalter 218 are components of a GOSP 200 train. The HPPT 222. LPPT 228, dehydrator 226, and desalter 218 are each a separator vessel that may have a horizontal orientation or vertical orientation. In some embodiments, the HPPT 222, LPPT 228, dehydrator 226, and desalter 218 are all horizontal vessels. In certain examples, the HPPT 222 vessel, LPPT 228 vessel, dehydrator 226 vessel, and desalter 218 vessel each have semi-elliptical-type heads, hemispherical heads, or torispherical heads.

The HPPT 222 vessel, LPPT 228 vessel, dehydrator 226 vessel, and desalter 218 vessel generally include nozzles (e.g., flanged, screwed connections, etc.) on the vessel body or heads to couple to conduits for receiving and discharging streams. An inlet on the vessel may be a nozzle that couples to (for example, connects to or attaches to) a feed or supply conduit to the vessel. An outlet on the vessel may be a nozzle (or multiple nozzles) that couples to a discharge conduit from the vessel. Nozzles on the vessels may also be employed for instrumentation (e.g., sensors, gauges, transmitters, etc.) and other uses.

In operation, the HPPT 222 receives the feed crude oil 202 via a conduit. The HPPT 222 as a separation vessel that provides for a three-phase separation. In particular, the HPPT 222 separates gas 230 and water 220 from the feed crude oil 202 and discharges crude oil 232. This HPPT water 220 discharge stream is generally not oily due to the fact that there is typically a constant water level in the HPPT 222, which keeps the oil droplets at the interface, not in the bulk. The HPPT 222 vessel may include an inlet separation device to promote separation of the gas 230 from the feed crude oil 202. The inlet separation device may promote an initial gross separation by changing the flow direction of the feed crude oil 202 entering the HPPT 222 vessel. The inlet separation device may be, for example, an inlet diverter, a vane-type inlet device, or a cyclonic inlet device.

The HPPT 222 as a three-phase separator vessel utilizes gravity or density difference to separate the water 220 from the crude oil 232. For instance, the HPPT 222 vessel includes a weir to facilitate the separation in which the oil (the lighter of the two liquids) overflows the weir. The water 220 generally discharges from within the weir. The separated water 220 is sent, for example, to a water/oil separator (WOSEP) 234 vessel and/or the MEC 248. In implementations, the operating pressure in the HPPT 222 is be at least 50 pounds per square inch gauge (psig). The operating temperature in the HPPT 222 is, for example, at least about 65° F., or in a range of 65° F. to 160° F.

The separated gas 230 that discharges from the HPPT 222 generally includes light hydrocarbons. The feed crude oil 202 is reduced in pressure in the HPPT 222 to separate the gas 230. In some embodiments, the gas 230 is light hydrocarbons (C1-C4) having a number of carbons in the range 1 to 4 and trace amount of C5+ hydrocarbons having five or more carbons. In examples, the gas 230 as a light (or lighter) hydrocarbon stream generally includes C1-C4 components (e.g., methane, ethane, propane, butane, isobutane) and trace amounts of C5+ compounds. The pressure of the discharged gas 230 may range in pressure, for example, from 50 psig to 450 psig depending, for instance, on the supply pressure of the feed crude oil 202. The gas 230 can include lighter hydrocarbons, traces of C5+ hydrocarbons, hydrogen sulfide (H₂S), carbon dioxide (CO₂), nitrogen (N₂), and water vapor. The relative amounts and types of compounds in the gas 230 typically depends on composition of the feed crude oil 102 and the flash pressure in the HPPT 222. The separated gas 230 can, for example, be sent to a mechanical compressor or to a gas plant for recovery.

The crude oil 232 is discharged from the HPPT 222 via a conduit to the LPPT 228. The motive force for flow of the crude oil 232 may be pressure differential. The LPPT 228 operates at a lower pressure than the HPPT 222. In implementations, the operating pressure in the LPPT 228 is equal to or less than 3 psig. The operating temperature of the LPPT 228 is, for example, at least about 65° F., or in a range of 65° F. to 160° F. The LPPT 228 vessel may include an inlet device to promote an initial gross separation of gas 236 from the crude oil 232 by changing the flow direction of the entering crude oil 232.

The LPPT 228 is a two-phase separation vessel or three-phase separation vessel. The LPPT 228 separates gas 236 (e.g., certain remaining off-gases) from the crude oil 232 and discharges a crude oil 238 stream. The gas 236 typically includes heavier hydrocarbons. The medium or heavy hydrocarbon stream as the gas 236 may refer generally to C5+(five-carbon and greater)hydrocarbons (e.g., pentane, isopentane, hexane, and heptane) and trace amounts of lighter hydrocarbons and other light components. In certain examples, the gas 236 discharges at a pressure of, at least 3 psig, or in a range of 3 psig to 90 psig. The gas 236 can, for example, be sent to a mechanical compressor or gas compression plant for recovery.

The crude oil 238 discharged from the LPPT 228 is sent to the dehydrator 226. In some implementations, the crude oil is pumped from the LPPT 228 to the dehydrator 226 via a pump (not shown). The pump can, for example, be a centrifugal pump. In certain implementations, the crude oil 238 flows through a heat exchanger (not shown) to heat the crude oil 238. The heat exchanger can be, for example, a shell-and-tube heat exchanger, a plate-and-frame heat exchanger, etc. In operation, the pump head provides motive force for flow of the crude oil 238 through the heat exchanger to the dehydrator 226. The heat exchanger heats the crude oil 238 to advance downstream separation of water and salt from the crude oil. This increase in temperature of the crude oil 238 may reduce fluid viscosity and may promote settling of water droplets from the crude oil in downstream processing. The heat transfer fluid for the heat exchanger can be, for example, steam or steam condensate, or a process stream (e.g., crude oil from a stabilizer column 244). The crude oil 238 can be heated in the heat exchanger via cross-exchange with other crude oil to recover heat from the other crude oil. In some embodiments, a low-pressure degassing tank (LPDT) (not shown) can replace the LPPT 228 and may be operationally disposed between the HPPT 222 and the dehydrator 226.

In the dehydrator 226 vessel, water 224 is separated from the crude oil 238. Salt discharges with the water 224 and thus is removed from the crude oil 240. Electrostatic coalescence may be employed in the dehydrator 226. In implementations, an electrostatic field is generated between electrodes in the dehydrator 226 vessel. Electrostatic coalescence applies an electric current, causing water droplets in the crude oil (emulsion) to collide, coalesce into larger (heavier) drops, and settle out of the crude oil as separate liquid water. This process partially dries wet crude oil. In one example, operating conditions of a dehydrator 226 unit include temperature in a range of 70° F. to 160° F., and a pressure at about 25 psig above the crude oil 240 vapor pressure. In some examples, fresh or recycle wash water (e.g., relatively low in salt) and/or chemicals are injected into the dehydrator 226 vessel to advance separation of the water 224 from the crude oil 238. The separated water 224 discharged from the dehydrator 226 can include oily water (e.g., having salt). In examples, oily water has less than 10 volume percent (vol. %) or less than 1 vol. % oil. The dehydrator 226 vessel discharges crude oil 240 via a conduit to the desalter 218 vessel. The crude oil 240 is labeled as dehydrated crude oil with some salt removed in implementations.

The salt removal in the GOSP 200 can be multi-stage. Both the desalter 218 and the dehydrator 226 may provide for salt removal. Thus, the embodiment of FIG. 2 may be two-stage desalting (salt removal). Moreover, in some examples, the desalter 218 can be two or more desalter vessels in series.

In the illustrated example, a single desalter 218 vessel is depicted. Water 242 having salt discharges from the desalter 218 and can be recycled to the dehydrator 226 or flowed to the MEC 248. Wash water 216 (e.g., fresh water) may be added to the desalter 218 vessel to facilitate removal of salt from the crude oil 240. Wash water 216 can be supplied to the desalter 218 to promote the separation generated by the electrostatic field in the desalter 218 vessel. The wash water 216 can be injected into the dehydrated crude oil 240 entering the desalter 218 to wash the crude oil to meet the salt content specification of the produced crude (export crude oil 204). The water 216 added is low in salt concentration relative to the salt concentration of water (e.g., emulsified water) in the crude oil 240. Fresh wash water (as opposed, for example, to recycle water having more salt) can be utilized in the desalting process to increase the amount of salt rinsed from the crude oil 240. Wash water 216 salinity (total dissolved solids. TDS) can range, for example, from between about 100 parts per million (ppm) to about 12,000 ppm. Again, wash water 216 is more effective if the salinity (TDS) level is low. In comparison, formation water salinity produced with crude oil can reach as high as about 400,000 ppm of salt or more.

The flowrate of the wash water 216 may be controlled via a flow control valve. The valve opening (e.g., percent open) of the flow control valve may be adjusted by a flow controller (FC) to maintain flowrate of the wash water 216 per a flowrate set point of the flow controller for the control valve. The set point for the control valve may be manually set locally or manually entered into the control system. On the other hand, the specifying of the flowrate of the wash water 216 may be automated. In particular, the set point for the control valve is determined and specified by the control system based on feedback from online analyzer instruments and meters in the GOSP 200.

In addition to (or in lieu of) the control valve, flowrate of the wash water 216 can be controlled via the speed of the pump supplying the wash water 216. The pump can, for example, a centrifugal pump. The speed of the pump can be manually set. In some embodiments, the control valve determines and specifies the speed of the pump to give the desired flowrate of wash water 216. The desired flow rate can be control-system specified based at least (based in part) on measurements by the analyzer instruments. To give the desired flowrate of wash water 216, the speed of the pump is set, for example, by adjusting the pump stroke (e.g., the number of strokes per time, the number of stroke cycles per time, the length of a stroke, etc.). In some implementations, the adjustment of the pump stroke is manual (local) or remotely adjusted by the control system to give the flowrate wash water 216 specified by the control system.

As in the upstream dehydrator 226, electrostatic coalescence may be employed in the desalter 218 vessel. Electrostatic coalescence facilitates removal of water from crude oil 140. Operating conditions in the desalter 218 can, for example, include a temperature in a range of 70° F. to 160° F. and an operating pressure at least 25 psig above vapor pressure of the crude oil 240. The wash water 216 increases the water droplet number concentration to promote coalescence to form larger and more easily separated water droplets to meet the crude salt content specification. Both the flowrate and quality (salinity) of wash water 216 affect the crude desalting process. The desalter 218 reduces the salt content of crude oil 240, for example, to less than 10 pounds of salt per thousand barrels (PTB) of oil.

The crude oil that discharges from the desalter 218 can be the export crude oil 204. The desalter 218 discharges the export crude oil 204 for distribution including to storage 246 and transportation, and for further processing such as in a petroleum refinery. The export crude oil 204 is labeled as processed crude oil, product crude oil, stabilized crude oil, and so forth. The salt content of the export crude oil 204 can be monitored manually by periodically determining the salt content through laboratory analysis (e.g., once per 8-hour shift). The salt content of the export crude oil 204 can be continuously monitored with an automated online analyzer. The output from the online analyzer can be used, in part, to control the wash water flow rate to the desalter 218. The salt content of the export crude oil 204 can be monitored by determining the salt content based on calculating a salt mass balance (e.g., in real time) in the GOSP 200 utilizing online data for streams in the GOSP 200.

Specifications for the export crude oil 204 include, for example: (1) salt content less than 10 PTB; (2) basic sediment and water (BS&W) content less than 0.2 volume percent (vol %) of the crude oil; (3) hydrogen sulfide (H₂S) content less than 70 ppm by weight (ppmw); and (4) maximum true vapor pressure (TVP) (per ASTM D 2879) less than 13 pounds per square inch absolute (psia) at storage temperature. The BS&W is generally measured from a liquid sample of the crude oil. The BS&W includes water, sediment, and emulsion. The BS&W is typically measured as a volume percentage of the crude oil. The BS&W specification can be less than 0.5 vol % for Heavy crude oil and less than 0.2 vol % for other crude oils.

In some examples, the desalter 218 discharges the export crude oil 204 via a conduit to a stabilizer distillation column 244 that separates and removes light ends or light components (volatile components such as C1-C4 hydrocarbons) as gas from the export crude oil 204. These light components discharge as an overhead stream from the stabilizer distillation column. This removal of the light components reduces vapor pressure of the export crude oil 204 to give a desired vapor pressure of the export crude oil 204 as stabilized crude oil. The associated specification of the export crude oil 204 can be, for example, Reid vapor pressure (RVP) or true vapor pressure (TVP), or both. The term “stabilized” refers to the crude oil having a lower vapor pressure and thus being less volatile to facilitate tank storage and pipeline transport. The stabilization can, for example, lower the vapor pressure of the crude oil to at least 13 pounds per square inch (psi) below atmospheric pressure so that vapor will generally not flash under atmospheric conditions. The stabilizer distillation column 244 removes H₂S from the export crude oil 204 to sweeten the crude oil. The H₂S discharges in the overhead stream in the light components. The terms “sweet” crude oil or to “sweeten” crude oil refers to lower H₂S content in the crude oil. In the stabilizer distillation column 244, any H₂S gas dissolved in the export crude oil 204 is removed to meet crude-oil specification of H₂S content, for example, less than 60 ppm, or in a range of 10 ppm to 70 ppm. If a stabilizer distillation column 244 is employed, the stabilized export crude oil 204 is discharged as the bottom streams from the stabilizer distillation column 244 and pumped via the column bottoms pump to storage 246 or distribution.

The GOSP 200 can include a control system that facilitates or directs operation of the GOSP 200. For instance, the control system directs control of the supply or discharge of flow streams (including flowrate) and associated control valves, control of operating temperatures and operating pressures, and so on. The control system (or associated computer system) performs salt mass-balance calculations of the GOSP 200 to determine (monitor) the salt content in the export crude oil 204. The determination can be based on on-line analysis upstream (internal) in the GOSP 200. The salt content in the export crude oil 204 can be determined in real time (or substantially real time) without online analysis of the export crude oil 204 itself. The salt content in the export crude oil 204 can be determined in real time (or substantially real time) with manual sampling and/or online analysis of the export crude oil 204.

In some implementations, the control system calculates or otherwise determines set points of control devices. For instance, the control system specifies the set point of a flow control valve (or specify number of strokes per time for a wash-water supply pump) on the wash water 216 supply to the desalter 218. In some cases, the set point of a control device is input manually. In some cases, the set point of a control device is calculated and/or adjusted by the control system.

The control system can include a processor and memory storing code (e.g., logic, instructions, etc.) executed by the processor to perform calculations and direct operations of the GOSP 200. The processor (hardware processor) may be one or more processors and each processor may have one or more cores. The processor(s) can include a microprocessor, central processing unit (CPU), graphic processing unit (GPU), controller card, circuit board, or other circuitry. The memory can include volatile memory (for example, cache or random access memory), nonvolatile memory (for example, hard drive, solid-state drive, or read-only memory), and firmware. The control system can include a desktop computer, laptop computer, computer server, control panels, programmable logic controller (PLC), distributed computing system (DSC), controllers, actuators, or control cards.

The control system can be communicatively coupled to a remote computing system that performs calculations and provides direction. The control system can receive user input or remote-computer input that specifies the set points of control devices or other control components in the GOSP 200. The control system can employ local control panels distributed in the GOSP 200. Certain implementations include a control room that can be a center of activity, facilitating monitoring and control of the GOSP 200 process or facility. The control room can contain a human machine interface (HMI), which is a computer, for example, that runs specialized software to provide a user-interface for the control system. The HMI can vary by vendor and present the user with a graphical version of the remote process. There can be multiple HMI consoles or workstations, with varying degrees of access to data.

As indicated, after dewatering the crude oil 202 emulsion in the phase separators HPPT 222 and LPPT 228 (and/or LPDT), the crude oil 238 stream undergoes a stage of desalting at each of the dehydrator 226 and the desalter 218. If not desalted, the small brine droplets contained in the crude oil 238 stream leaving the LPPT 228 (or LPDT) may corrode pipes and storage tanks. In addition to the corrosion of metallic equipment, high concentration of salts within these brine droplets could foul or plug trays in distillation columns, heat-exchanger tubes, etc. at downstream refineries. Therefore, the level of salt in the export crude oil 204 is regulated and controlled, for example, to under 10 pounds salt (as sodium chloride equivalent) per 1.000 barrels crude oil (10 lbm salt/1000 bbl crude oil or PTB) for transportation and storage, and to under 1 lbm salt/bbl crude oil for petroleum refineries. One pound salt per thousand barrels is equivalent to 28.5 gram of salt/m³ (or ppmw). In some examples, the water volume fraction (level of residual brine) is regulated and controlled to maximum 0.5 volume percent (vol %) for heavy crude oils (e.g., Heavy Arabian crude oil) and maximum 0.2 vol % for other crude oils (e.g., Arabian crude oils). The water volume fraction may be regulated and controlled to other product-specification values (vol %) for water volume fraction as applicable for other types or grades of crude oil, or may be customer dependent.

As indicated, aspects of the present disclosure provide: (1) real-time, automated wash-water 216 flowrate to the desalter 218 for control of salt content in the export crude oil 204; and (2) real-time monitoring (via calculation) of the salt content in the export crude oil 204 that exits the desalter 218.

The GOSP 200 includes an MEC 248. The MEC 248 can receive water from various sources (such as the HPPT 222, the LPPT 228, the dehydrator 226, the desalter 218, or any combinations of these) via a conduit. For example, the MEC 248 receives water 220 from the HPPT 222, water 221 from the LPPT 228, water 224 from the dehydrator 226, water 242 from the desalter 218, or any combinations of these. The MEC 248 electrolyzes hydrocarbons present in the water to produce hydrogen gas 250 and a treated water stream 252. The hydrogen gas 250 can be used to generate electrical power. For example, the hydrogen gas 250 can be flowed to a hydrogen fuel cell 251 where it is oxidized (combined with oxygen) to generate electrical power. As another example, the hydrogen gas 250 can be combusted to generate electrical power (for example, via a gas turbine). The treated water stream 252 can be sent to the WOSEP 234. In some implementations, the WOSEP 234 receives wash water 254 from a desalination plant 256. As described previously, the WOSEP 234 can separate any residual oil from the bulk water phase. The WOSEP 234 may discharge a water stream 234a and a recovered oil stream 234b. The recovered oil stream 234b can be sent to storage 246.

In some implementations, the GOSP 200 includes a second MEC 258. The second MEC 258 electrolyzes residual hydrocarbons present in the water stream 234a to produce hydrogen gas 260 and a treated water stream 262. The hydrogen gas 260 can be used to generate electrical power. For example, the hydrogen gas 260 can be flowed to the hydrogen fuel cell 251 where it is oxidized to generate electrical power. As another example, the hydrogen gas 260 can be combusted to generate electrical power (for example, via a gas turbine). At least a portion of the treated water stream 262 is flowed to the desalter 218 to be used as wash water. A remaining portion of the treated water stream 262 can, for example, be sent to a utility plant for further processing, be injected into the Earth via a water injection/disposal well 264, or both. In cases where the treated water stream 262 is sufficient to provide water to the desalter 218, the fresh wash water stream 216 can be omitted. In implementations in which the second MEC 258 is omitted, at least a portion of the water stream 234a can instead be recycled to the desalter 218 to be used as wash water. A remaining portion of the water stream 234a can, for example, be sent to a utility plant for further processing, be injected into the Earth via a water injection/disposal well 264, or both.

In some implementations, the water stream(s) (water 101c from the WOSEP 106, water 220 from the HPPT 222, water 221 from the LPPT 228, water 224 from the dehydrator 226, water 242 from the desalter 218, water 234a from the WOSEP 234, or any combinations of these) received by the MEC 248 and/or the second MEC 258 can have a TDS level in a range of from about 150,000 ppm to about 250,000 ppm and a total suspended solids (TSS) level in a range of from about 100 ppm to about 200 ppm. In some implementations, the water stream(s) (water 101c from the WOSEP 106, water 220 from the HPPT 222, water 221 from the LPPT 228, water 224 from the dehydrator 226, water 242 from the desalter 218, water 234a from the WOSEP 234, or any combinations of these) received by the MEC 248 and/or the second MEC 258 can have an oil content in a range of from about 10 ppm to about 30,000 ppm. Table 1 provides an example composition of the water stream(s) (water 101c from the WOSEP 106, water 220 from the HPPT 222, water 221 from the LPPT 228, water 224 from the dehydrator 226, water 242 from the desalter 218, water 234a from the WOSEP 234, or any combinations of these) received by the MEC 248 and/or the second MEC 258.

TABLE 1
Example wastewater stream composition entering an MEC

| Component/Property | Units | Range |
|---|---|---|
| Bicarbonate | ppm | 100-1,500 |
| Carbonate | ppm | 0 |
| Hydroxide | ppm | 0 |
| Sulfate | ppm | 300-4,500 |
| Chloride | ppm | 40,000-105,000 |
| Conductivity | ppm | >10,000 |
| Iron | ppm | <1 |
| Calcium | ppm | 13,000-35,000 |
| Magnesium | ppm | 1,500-2,500 |
| Sodium | ppm | 24,000-51,000 |
| Potassium | ppm | 1,900-3,000 |
| pH at 25° C. | | 6.3-7.3 |
| TDS | ppm | 157,000-250,000 |
| Specific gravity | | 1.1116-1.1202 |
| Barium | ppm | 4-5 |
| Strontium | ppm | 50-1,300 |
| TSS | ppm | 150-165 |
| Oil content | ppm | 10-30,000 |

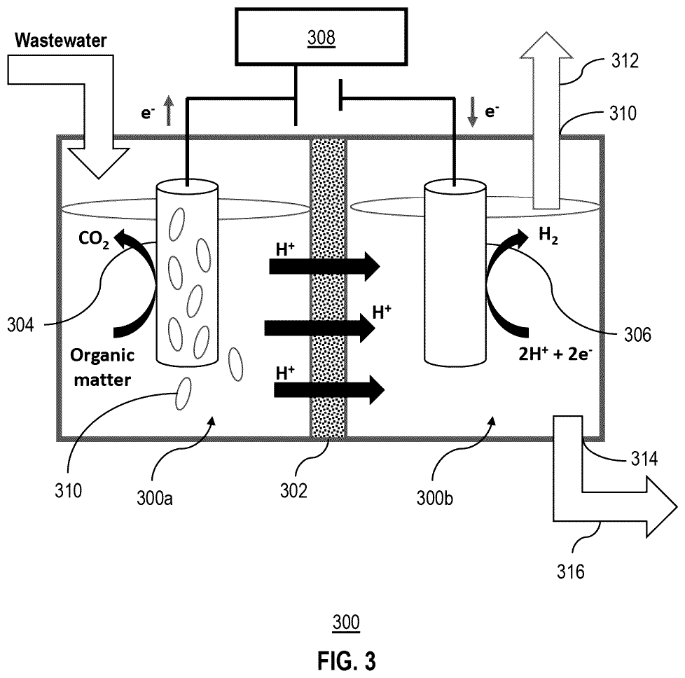

FIG. 3 is a schematic diagram of an example MEC 300 that can be implemented in any of the GOSPs 100 or 200. The MEC 300 can, for example, replace any of the implementations of the MEC 120 of FIG. 1, MEC 248 of FIG. 2, or the second MEC 258 of FIG. 2. The MEC 300 includes a membrane 302 that separates the MEC 300 into an anode side 300a and a cathode side 300b. The membrane 302 is a semi-permeable membrane that allows passage of certain species (such as ions and water) while blocking passage, of other species (such as neutral compounds, like hydrocarbons and solid material). In some implementations, the membrane 302 is an ion exchange membrane or a proton exchange membrane. The MEC 300 includes an anode 304 disposed in the anode side 300a. The MEC 300 includes a cathode 306 disposed in the cathode side 300b. The anode 304 and cathode 306 can be connected to a power source 308. The power source 308 can provide power to the MEC 300. The MEC 300 includes microbes 310 disposed in the anode side 300a. The microbes 310 are exoelectronic microbes that are able to convert biodegradable matter (for example, organic matter including hydrocarbons) into electric current and protons. The microbes 310 are electrochemically active microorganisms, such as extremophiles, cyanobacterium, dechlorinating bacteria, methanogens, homoacetogens, or any combinations of these. In some implementations, additional organic matter (apart from the hydrocarbons already present in the water provided to the anode side 300a of the MEC 300) is provided to the anode side 300a of the MEC 300. For example, acetate, acetic acid, butyric acid, lactic acid, propionic acid, valeric acid, formic acid, glycerol, ethanol, lactate, glucose, cellulose, maltose, saccharose, cellobiose, lignocellulose, starch, organic sludge, or any combinations of these are provided to the anode side 300a of the MEC 300, which can be processed by the microbes 310 to produce more protons. The microbes 310 are capable of processing organic matter to produce hydrogen ions despite the presence of contaminants that are typical in water that is produced in crude oil, such as mercaptans, oil/grease, phenols, ammonia, sulfide, and dissolved salts. The microbes 310 are capable of withstanding extreme environmental conditions, including high salinity and high temperature tolerance. The microbes 310 have high hydrogen production potential (for example, Clostridium species). The microbes 310 have electrogenicity capability (for example, Geobacter and Shewanella). The microbes 310 are electrochemically compatible with the wastewater stream. The microbes 310 can be metabolically flexible and can, for example, adapt to environment changes and metabolize various substrates in the wastewater stream. In some cases, the microbes 310 form a biofilm, which can facilitate electron transfer and improve performance and/or efficiency of the MEC 300. In some implementations, the microbes 310 include various microbes (for example, a mixed consortium of microbes) that work together to process the organic matter in the wastewater stream. For example, the microbes 310 can include microbes that can reduce the salinity in the wastewater stream. The microbial community dynamics of a mixed consortium can positively impact the overall system resilience and efficiency.

The MEC 300 receives a wastewater stream that includes water and hydrocarbons. For example, the MEC 300 receives water 101c from the WOSEP 106, water 220 from the HPPT 222, water 221 from the LPPT 228, water 224 from the dehydrator 226, water 242 from the desalter 218, water 234a from the WOSEP 234, or any combinations of these at the anode side 300a of the MEC 300 via a conduit. The MEC 300 can cooperate with the microbes 310 to electrolyze the hydrocarbons present in the water at the anode side 300a to produce hydrogen ions (protons) at the anode side 300a. Because the membrane 302 is permeable to protons, the protons produced at the anode side 300a pass through the membrane 302 to the cathode side 300b. The electrolysis that occurs at the anode side 300a also produces carbon dioxide and electrons. The electrons produced at the anode side 300a are transferred to the cathode side 300b via the electrodes 304, 306. At the cathode side 300b, the protons that have passed through the membrane 302 can combine together along with electrons to produce hydrogen gas at the cathode side 300b. The power supplied by the power source 308 can be used to facilitate the generation of hydrogen gas at the cathode side 300b. The MEC 300 includes an outlet 310 at the cathode side 300b for discharging a hydrogen gas stream 312 including the hydrogen gas produced at the cathode side 300b. The hydrogen gas stream 312 can then be oxidized to generate electrical power, which can be used, for example, elsewhere in the GOSP 100 or 200. For example, the hydrogen gas stream 312 can be flowed to the hydrogen fuel cell 251 or combusted in a gas turbine to generate electrical power. Because the membrane 302 is permeable to water and certain ions while blocking passage of other species (such as hydrocarbons), the water at the cathode side 300b is a treated water that contains less contaminants in comparison to the water at the anode side 300a. The MEC 300 includes an outlet 314 at the cathode side 300b for discharging the treated water 316. The treated water 316 exiting the MEC 300 from the cathode side 300b contains less contaminants (that is, has a greater water concentration) in comparison to the water entering the MEC 300 at the anode side 300a.

In some implementations, the MEC 300 operates at mesophilic temperatures, such as temperatures in a range of from about 25 degrees Celsius (° C.) to about 40° C. In some implementations, the MEC 300 operates at thermophilic temperatures, such as temperature in a range of from about 50° C. to about 70° C. In some implementations, the anode side 300a of the MEC 300 operates at a pH level in a range of from about 5.5 to about 7.5. The pH of the anode side 300a of the MEC 300 can be adjusted, for example, based on the composition of the microbes 310 at the anode side 300a. In some implementations, the cathode potential (electrical potential) of the MEC 300 is in a range of from about 0.2 volts (V) to about 0.4 V. The cathode potential of the MEC 300 can be adjusted, for example, based on the electron transfer from the anode side 300a to the cathode side 300b and the conversion of protons into hydrogen gas at the cathode side 300b. The hydraulic retention time of the MEC 300 refers to the time for organic matter retaining in the MEC 300 and depends on the growth rate of the microbes 310 at the anode side 300a. The operating conditions, the composition of the microbes 310, or both can be adjusted to ensure that the amount of microbes 310 at the anode side 300a remain sufficient for processing the organic matter at the anode side 300a and the amount of organic matter at the anode side 300a does not accumulate at a significantly faster rate than the processing rate of the microbes 310. The anode 304 and cathode 306 (electrodes) of the MEC 300 are constructed by materials that exhibit adequate electrical conductivity, stability, and catalytic activity for processing the organic matter and producing hydrogen gas.

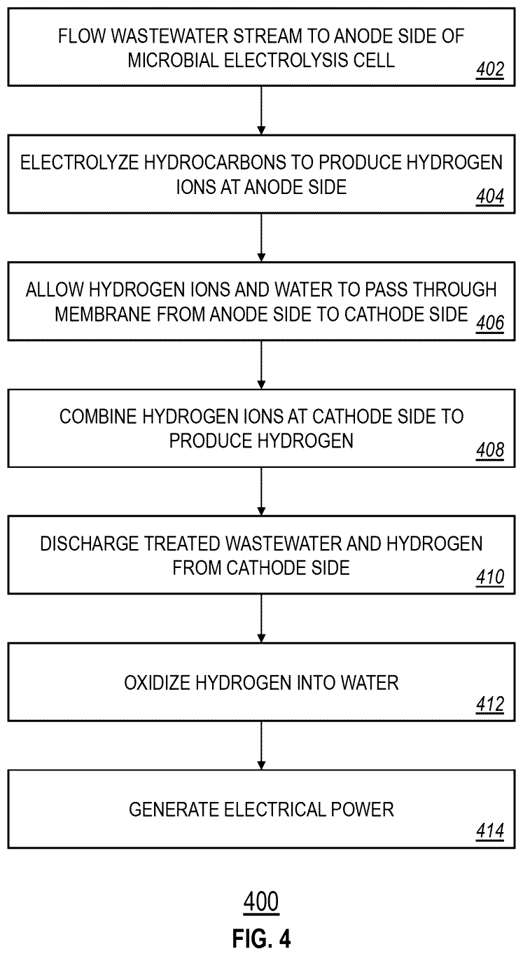

FIG. 4 is a flow chart of an example method 400 for powering portions of a GOSP (such as the GOSP 100 or 200). For example, any of the GOSPs 100 or 200 can implement the method 400. At block 402, a wastewater stream from a separator positioned in the GOSP 100 or 200 (for example, water 101c from the WOSEP 106, water 220 from the HPPT 222, water 221 from the LPPT 228, water 224 from the dehydrator 226, water 242 from the desalter 218, water 234a from the WOSEP 234, or any combinations of these) is flowed to an anode side (such as the anode side 300a) of a microbial electrolysis cell (such as the MEC 120, MEC 248, MEC 258, or MEC 300). The wastewater stream includes water and hydrocarbons. The MEC includes a membrane (such as the membrane 302) that separates the MEC into an anode side (such as the anode side 300a) and a cathode side (such as the cathode side 300b). At block 404, the MEC electrolyzes the hydrocarbons of the wastewater stream to produce hydrogen ions (protons) at the anode side. At block 406, the membrane allows hydrogen ions and water molecules to pass through the membrane from the anode side to the cathode side, thereby forming a treated wastewater stream (such as the treated water 316) at the cathode side. At block 408, the MEC combines the hydrogen ions (and electrons) to produce hydrogen gas. At block 410, the treated wastewater stream and a hydrogen gas stream (such as the hydrogen gas stream 312) including the produced hydrogen gas are discharged from the cathode side of the MEC. At block 412, the hydrogen gas stream is oxidized into water. For example, the hydrogen gas stream is flowed to a hydrogen fuel cell (such as the hydrogen fuel cell 251), where the hydrogen fuel cell reacts the hydrogen with oxygen to produce water at block 412. As another example, the hydrogen gas stream is flowed to a gas turbine where it is combusted at block 412. At block 414, electrical power is generated in response to oxidizing the hydrogen gas into water at block 412. For example, the hydrogen fuel cell generates electrical power at block 414 in response to oxidizing the hydrogen gas at block 412. As another example, combustion of the hydrogen gas stream in the gas turbine at block 412 causes turbine blades of the gas turbine to rotate, thereby generating electrical power at block 414. The electrical power generated at block 414 can, for example, be used to power portion(s) of the GOSP 100 or 200. For example, the electrical power generated at block 414 can be used to operate pumps in the GOSP 100 or 200, electrify fluids to enhance oil/water separation and break emulsions (for example, in a coalescer in the GOSP 100 or 200), pump recycled treated wastewater to a disposal or injection well, or any combinations of these.

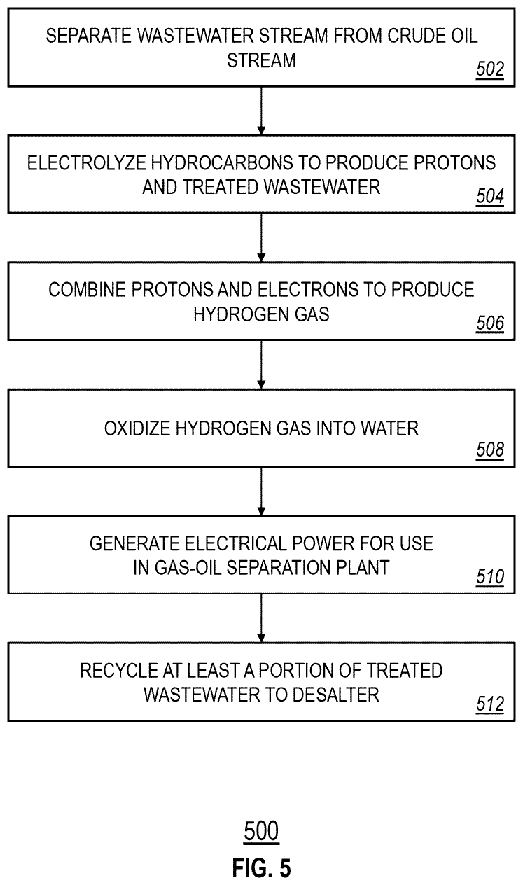

FIG. 5 is a flow chart of an example method 500 for powering portions of a GOSP (such as the GOSP 100 or 200). For example, any of the GOSPs 100 or 200 can implement the method 500. At block 502, a wastewater stream is separated from a crude oil stream in a separator positioned in the GOSP 100 or 200. The wastewater stream includes water and hydrocarbons. As a few examples for block 502, water 101c is separated from the hydrocarbon stream 101 in the WOSEP 106, water 220 is separated from the feed crude oil 202 in the HPPT 222, water is separated from the crude oil 232 in the LPPT 228, water 224 is separated from the crude oil 238 in the dehydrator 226, water is separated from the crude oil 240 in the desalter 218, water 234a is separated from oil in the WOSEP 234, or any combinations of these. The wastewater stream that is separated from the crude oil stream at block 502 includes water and hydrocarbons. At block 504, the hydrocarbons of the wastewater stream are electrolyzed to produce protons and a treated wastewater (such as the treated water 316). Any of the MEC 120, MEC 248, MEC 258, or MEC 300, for example, can perform the block 504. At block 506, the protons produced at block 504 are combined with electrons to produce hydrogen gas (such as the hydrogen gas stream 312). Any of the MEC 120, MEC 248, MEC 258, or MEC 300, for example, can perform the block 506. At block 508, the hydrogen gas is oxidized into water. For example, the hydrogen gas is flowed to a hydrogen fuel cell (such as the hydrogen fuel cell 251), where the hydrogen fuel cell reacts the hydrogen with oxygen to produce water at block 508. As another example, the hydrogen gas stream is flowed to a gas turbine where it is combusted at block 508. At block 510, electrical power is generated in response to oxidizing the hydrogen gas into water at block 508. For example, the hydrogen fuel cell generates electrical power at block 510 in response to oxidizing the hydrogen gas at block 508. As another example, combustion of the hydrogen gas stream in the gas turbine at block 508 causes turbine blades of the gas turbine to rotate, thereby generating electrical power at block 510. The electrical power generated at block 510 can, for example, be used to power portion(s) of the GOSP 100 or 200. At block 512, at least a portion of the treated wastewater produced at block 504 is recycled to a desalter (such as the desalter 218) positioned in the GOSP 200.

### Embodiments

In an example embodiment (or aspect), a method for powering portions of a GOSP comprises: flowing a wastewater stream comprising water and hydrocarbons from a separator positioned in the gas-oil separation plant to an anode side of a microbial electrolysis cell; electrolyzing, by the microbial electrolysis cell, the hydrocarbons to produce hydrogen ions at the anode side; allowing, by a membrane separating the microbial electrolysis cell into the anode side and a cathode side, the hydrogen ions and water molecules to pass through the membrane from the anode side to the cathode side, thereby forming a treated wastewater stream at the cathode side; combining, by the microbial electrolysis cell, the hydrogen ions at the cathode side to produce hydrogen gas; discharging, from the cathode side, the treated wastewater stream and a hydrogen gas stream comprising the hydrogen gas; oxidizing the hydrogen gas stream into water; and generating electrical power in response to oxidizing the hydrogen gas into water.

In an example embodiment (or aspect), a method for powering portions of a GOSP comprises: separating a wastewater stream comprising water and hydrocarbons from a crude oil stream in a separator positioned in the gas-oil separation plant; electrolyzing the hydrocarbons of the wastewater stream to produce protons and a treated wastewater; combining the protons and electrons to produce hydrogen gas; oxidizing the hydrogen gas into water; in response to oxidizing the hydrogen gas into water, generating electrical power for use in the gas-oil separation plant; and recycling at least a portion of the treated wastewater to a desalter positioned in the gas-oil separation plant.

In an example embodiment (or aspect), a system for powering portions of a GOSP comprises: a wastewater stream comprising water and hydrocarbons from a separator positioned in the gas-oil separation plant; a microbial electrolysis cell comprising a membrane separating the microbial electrolysis cell into an anode side and a cathode side, the microbial electrolysis cell comprising an anode disposed in the anode side and a cathode disposed in the cathode side, wherein the anode and the cathode are configured to connect to a power source, wherein microbes are disposed within the anode side, wherein the microbial electrolysis cell is configured to receive the wastewater stream at the anode side, wherein the anode and the microbes are cooperatively configured to electrolyze the hydrocarbons in response to receiving power from the power source to produce hydrogen ions at the anode side, wherein the membrane is configured to allow the hydrogen ions and water molecules to pass through the membrane from the anode side to the cathode side to form a treated wastewater stream at the cathode side, wherein the cathode is configured to combine the hydrogen ions at the cathode side to produce hydrogen gas, wherein the microbial electrolysis cell is configured to discharge, from the cathode side, the treated wastewater stream and a hydrogen gas stream comprising the hydrogen gas; and a hydrogen fuel cell configured to receive the hydrogen gas stream and oxygen, wherein the hydrogen fuel cell is configured to convert the oxygen and the hydrogen gas from the hydrogen gas stream into water, and the hydrogen fuel cell is configured to generate power in response to converting the oxygen and the hydrogen gas into water.

In an example embodiment (or aspect) combinable with any other example embodiment (or aspect), the method further comprises providing the generated electrical power to the gas-oil separation plant.

In an example embodiment (or aspect) combinable with any other example embodiment (or aspect), the method further comprises recycling the treated wastewater stream to a desalter positioned in the gas-oil separation plant.

In an example embodiment (or aspect) combinable with any other example embodiment (or aspect), the method further comprises flowing the treated wastewater stream through a membrane separator, thereby purifying the treated wastewater stream and increasing a concentration of water in the treated wastewater stream prior to recycling the treated wastewater stream to the desalter.

In an example embodiment (or aspect) combinable with any other example embodiment (or aspect), the method further comprises combining the treated wastewater stream with seawater to form a mixed water stream, and flowing the mixed water stream to a water treatment plant.

In an example embodiment (or aspect) combinable with any other example embodiment (or aspect), the method further comprises combining a second portion of the treated wastewater stream with seawater to form a mixed water stream, and flowing the mixed water stream to a water treatment plant.

In an example embodiment (or aspect) combinable with any other example embodiment (or aspect), the method further comprises injecting the treated wastewater stream into a wellbore formed in a subterranean formation.

In an example embodiment (or aspect) combinable with any other example embodiment (or aspect), the method further comprises injecting a second portion of the treated waste water stream into a wellbore formed in a subterranean formation.

In an example embodiment (or aspect) combinable with any other example embodiment (or aspect), the system further comprises a desalter positioned in the gas-oil separation plant, wherein the desalter is configured to receive and utilize the treated wastewater stream from the microbial electrolysis cell as wash water.

In an example embodiment (or aspect) combinable with any other example embodiment (or aspect), the system further comprises a membrane separator configured to receive the treated wastewater stream, wherein the membrane separator is configured to, in response to the treated wastewater stream flowing through the membrane separator, purify the treated wastewater stream and increase a concentration of water in the treated wastewater stream.

In an example embodiment (or aspect) combinable with any other example embodiment (or aspect), the wastewater stream has a total dissolved solids level in a range of from about 150,000 ppm to about 250,000 ppm.

In an example embodiment (or aspect) combinable with any other example embodiment (or aspect), the wastewater stream has an oil content in a range of from about 10 parts per million (ppm) to about 30,000 ppm.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

As used in this disclosure, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed in this disclosure, and not otherwise defined, is for the purpose of description only and not of limitation. Any use of section headings is intended to aid reading of the document and is not to be interpreted as limiting; information that is relevant to a section heading may occur within or outside of that particular section.

As used in this disclosure, the term “about” or “approximately” can allow for a degree of variability in a value or range, for example, within 10%, within 5%, or within 1% of a stated value or of a stated limit of a range.

As used in this disclosure, the term “substantially” refers to a majority of, or mostly, as in at least about 50%, 60%, 70%, 80%, 90%, 95%, 96%, 97%, 98%, 99%, 99.5%, 99.9%, 99.99%, or at least about 99.999% or more.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “0.1% to about 5%” or “0.1% to 5%” should be interpreted to include about 0.1% to about 5%, as well as the individual values (for example, 1%, 2%, 3%, and 4%) and the sub-ranges (for example, 0.1% to 0.5%, 1.1% to 2.2%, 3.3% to 4.4%) within the indicated range. The statement “X to Y” has the same meaning as “about X to about Y,” unless indicated otherwise. Likewise, the statement “X, Y, or Z” has the same meaning as “about X, about Y, or about Z,” unless indicated otherwise.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described components and systems can generally be integrated together or packaged into multiple products.

Accordingly, the previously described example implementations do not define or constrain the present disclosure. Other changes, substitutions, and alterations are also possible without departing from the spirit and scope of the present disclosure.

What is claimed is:

1. A method for powering portions of a gas-oil separation plant, the method comprising:
flowing a wastewater stream comprising water and hydrocarbons from a separator positioned in the gas-oil separation plant to an anode side of a microbial electrolysis cell:
electrolyzing, by the microbial electrolysis cell, the hydrocarbons to produce hydrogen ions at the anode side;
allowing, by a membrane separating the microbial electrolysis cell into the anode side and a cathode side, the hydrogen ions and water molecules to pass through the membrane from the anode side to the cathode side, thereby forming a treated wastewater stream at the cathode side;
combining, by the microbial electrolysis cell, the hydrogen ions at the cathode side to produce hydrogen gas;
discharging, from the cathode side, the treated wastewater stream and a hydrogen gas stream comprising the hydrogen gas;
oxidizing the hydrogen gas stream into water; and
generating electrical power in response to oxidizing the hydrogen gas into water.

2. The method of claim 1, further comprising providing the generated electrical power to the gas-oil separation plant.

3. The method of claim 2, further comprising recycling the treated wastewater stream to a desalter positioned in the gas-oil separation plant.

4. The method of claim 2, further comprising flowing the treated wastewater stream through a membrane separator, thereby purifying the treated wastewater stream and increasing a concentration of water in the treated wastewater stream prior to recycling the treated wastewater stream to the desalter.

5. The method of claim 2, further comprising combining the treated wastewater stream with seawater to form a mixed water stream, and flowing the mixed water stream to a water treatment plant.

6. The method of claim 2, further comprising injecting the treated wastewater stream into a wellbore formed in a subterranean formation.

7. The method of claim 2, wherein the wastewater stream has a total dissolved solids level in a range of from about 150,000 parts per million (ppm) to about 250.000 ppm.

8. The method of claim 2, wherein the wastewater stream has an oil content in a range of from about 10 parts per million (ppm) to about 30,000 ppm.

9. A method for powering portions of a gas-oil separation plant, the method comprising:
separating a wastewater stream comprising water and hydrocarbons from a crude oil stream in a separator positioned in the gas-oil separation plant;
electrolyzing the hydrocarbons of the wastewater stream to produce protons and a treated wastewater;
combining the protons and electrons to produce hydrogen gas;
oxidizing the hydrogen gas into water;
in response to oxidizing the hydrogen gas into water, generating electrical power for use in the gas-oil separation plant; and
recycling at least a portion of the treated wastewater to a desalter positioned in the gas-oil separation plant.

10. The method of claim 9, further comprising providing the generated electrical power to the gas-oil separation plant.

11. The method of claim 10, further comprising flowing the treated wastewater stream through a membrane separator, thereby purifying the treated wastewater stream and increasing a concentration of water in the treated wastewater stream prior to recycling at least the portion of the treated wastewater stream to the desalter.

12. The method of claim 10, further comprising combining a second portion of the treated wastewater stream with seawater to form a mixed water stream, and flowing the mixed water stream to a water treatment plant.

13. The method of claim 10, further comprising injecting a second portion of the treated wastewater stream into a wellbore formed in a subterranean formation.

14. The method of claim 10, wherein the wastewater stream has:
a total dissolved solids level in a range of from about 150.000 parts per million (ppm) to about 250,000 ppm; and
an oil content in a range of from about 10 ppm to about 30,000 ppm.

15. A system for powering portions of a gas-oil separation plant, the system comprising:
a wastewater stream comprising water and hydrocarbons from a separator positioned in the gas-oil separation plant;
a microbial electrolysis cell comprising a membrane separating the microbial electrolysis cell into an anode side and a cathode side, the microbial electrolysis cell comprising an anode disposed in the anode side and a cathode disposed in the cathode side, wherein the anode and the cathode are configured to connect to a power source, wherein microbes are disposed within the anode side, wherein the microbial electrolysis cell is configured to receive the wastewater stream at the anode side, wherein the anode and the microbes are cooperatively configured to electrolyze the hydrocarbons in response to receiving power from the power source to produce hydrogen ions at the anode side, wherein the membrane is configured to allow the hydrogen ions and water molecules to pass through the membrane from the anode side to the cathode side to form a treated wastewater stream at the cathode side, wherein the cathode is configured to combine the hydrogen ions at the cathode side to produce hydrogen gas, wherein the microbial electrolysis cell is configured to discharge, from the cathode side, the treated wastewater stream and a hydrogen gas stream comprising the hydrogen gas; and
a hydrogen fuel cell configured to receive the hydrogen gas stream and oxygen, wherein the hydrogen fuel cell is configured to convert the oxygen and the hydrogen gas from the hydrogen gas stream into water, and the hydrogen fuel cell is configured to generate power in response to converting the oxygen and the hydrogen gas into water.

16. The system of claim 15, further comprising a desalter positioned in the gas-oil separation plant, wherein the desalter is configured to receive and utilize the treated wastewater stream from the microbial electrolysis cell as wash water.

17. The system of claim 15, further comprising a membrane separator configured to receive the treated wastewater stream, wherein the membrane separator is configured to, in response to the treated wastewater stream flowing through the membrane separator, purify the treated wastewater stream and increase a concentration of water in the treated wastewater stream.

18. The system of claim 15, wherein the wastewater stream has a total dissolved solids level in a range of from about 150,000 parts per million (ppm) to about 250,000 ppm.

19. The system of claim 15, wherein the wastewater stream has an oil content in a range of from about 10 parts per million (ppm) to about 30,000 ppm.
